(19) United States
(12) Patent Application Publication
(10) Pub. No.: US 2002/0022996 A1
(43) Pub. Date: Feb. 21, 2002

(54) Method for advertising via the internet

(76) Inventors: David W. Sanborn, Austin, TX (US); Robert E. Smoot III, Austin, TX (US)

Correspondence Address: David Phillips, 3033 Thrushwood Cv, Austin, TX, 78757, US

(21) Appl. No.: 09/825,241

(22) Filed: Apr. 4, 2001

Related U.S. Application Data
(60) Provisional application No. 60/193,942, filed on Mar. 31, 2000.

(51) Int. Cl. G06F 17/60

(52) U.S. Cl. 705/14

(57) ABSTRACT

A method for producing and directing advertising messages, where the user self-selects an advertising image from a gallery of such images, for one side of a product, then supplies a personal message and mailing address for the other side of the product, and the producer (a service provider) employing this method then prints and mails the product to the indicated address.

The method enables three unrelated parties to cooperate in a disconnected yet mutually beneficial manner, where each receives significant value from their interaction with this method. A fourth party—a service provider operating the invention that embodies this method—interacts with each of the other three parties to coordinate providing the valuable service.

Advertisers receive the beneficial value of having their advertising messages combined with a message from a trusted party and then directed to a third party about which the advertiser had no foreknowledge. The users receive the beneficial value of having a portion or all of the costs associated with preparing and mailing a message product borne by a sponsor. The recipients of user messages receive the beneficial value of a desirable or useful message from a friend or a trusted professional.

### THE BACKGROUND OF THE INVENTION

A. The Field of the Invention

This invention relates to the field of using a computer or computer systems to enable a novel method for creating and targeting unique advertising messages.

B. Background Information

Traditional advertisement products such as newspaper, magazine, and other print media ads; radio, television, Internet and other electronic media ads; and direct mail have the advantage of wide distribution.

And even though advertisers may apply demographics research in an effort to better target their message, they still reach many people who have no interest in the product advertised.

Advertisers invest heavily in demographics research as a way to target their message beforehand. And afterwards they invest in many creative methods to track the results of their advertising. The advertisers want very much to put their message before only those people that seem likely suspects to purchase the product of the advertiser.

Despite the application of extensive demographics research, industry analysis (Direct Marketing Association) reports that about 97 out of 100 advertising mailings go straight to the trash. The method of this invention produces messages almost guaranteed to make the journey from mailbox to an individual's desk or dresser. This results because the message comes with the implicit endorsement of the sender, and it carries personal or reminder information the user wants or needs.

Even with World Wide Web (the web) advertising, and sophisticated new opportunities for profiling users by observing their actions, the advertiser still faces the task of trying to predict which users will make good suspects for their product.

Suppose, however, we have an individual (or enterprise) who personally knows an individual and knows something about their activities and interests. They have some form of pre-existing relationship, unlike the mass media advertiser that takes scattergun blasts in the dark at unknown targets.

In return for the benefit of receiving a free, or at least significantly subsidized, mailing, the user will select an advertising image to “carry” their personal message to an intended recipient. So we expect either the user (the sender) or the recipient or both to have some affinity for the product being advertised.

Some examples will illustrate this affinity principle. A person wanting to congratulate their friend who recently purchased a new VW car might choose a VW advertising image on which to send their message. An uncle sending a note to a niece who he knows takes a keen interest in the stock market might choose a Charles Schwab image on which to send their message. A dentist wanting to remind a patient of their appointment date might choose a dental care product, such as Colgate, for their message.

We can see in each of these cases that the advertising message comes with an implicit endorsement of the sender. So in addition to more highly targeting advertising messages to persons with a likely interest in the message, the messages carry more weight because of the pre-existing relationship, whether personal or professional, between the sender and the recipient.

The method described here creates an efficient system for creating and managing a beneficial relationship among three parties: an advertiser with a message to target; a beneficial user (the sender) who wants to send a real print message to someone they know, and who will enjoy the benefit of having the expense of this printing and mailing subsidized by an advertising sponsor; and a recipient who receives a desired message from someone they know.

### A SUMMARY OF THE INVENTION

Here we describe a method for creating a beneficial relationship between three parties: an advertiser, a sender of a message, and the recipient of the message.

In various embodiments of the invention, an advertising server presents to the user a gallery of advertising images that convey some form of advertising message.

Advertisers pre-supply the service provider employing this method with one or more advertising images, keywords and phrases to associate with the image, and any constraints on usage of that image.

The advertising server maintains a dynamic library of such images, and controls which images to show to a user depending on the constraints imposed by the advertiser and the requests of the user.

The advertising server produces a series of displays that permit the user to browse or search among the available images until they select one. Once the user has selected an image the server advances the user through a series of displays that help the user enter their message and an address, and possibly optional elements, such as an uploaded image, a manufacturer's coupon, or other image or text.

When the user indicates they have completed the transaction the server stores all information necessary to carry out the request specified in the transaction.

The advertising server or a separate production server or servers may handle the actual production of the transaction product. This entails reading and interpreting the user instructions, collecting all the requested image data, encoding the complete results for production on a suitable printing device.

The advertising server or production server or a separate printing server or servers may handle the actual printing of the transaction product. This may entail optimizing the order and arrangement of print products to reduce production costs or increase quality. For example, the print server might print mailings in zip code order to facilitate handling as bulk mail.

The service provider employing the process of this invention may locate and operate the print server at their own facilities or at those of other service providers.

Although the description and figures include many claims, the scope of the claims section alone defines the invention. Only limitations found in those claims apply to the invention.

### BRIEF DESCRIPTION OF THE DRAWINGS

The figures illustrate the invention by way of example, and not limitation. Like references indicate similar elements.

FIG. 1 depicts the overall relationship among three parties, all users of the invention, and the invention.

FIG. 2 depicts the computer process for handling the user interaction.

FIG. 3 depicts the computer process for maintaining the image database.

FIG. 4 depicts the application of the invention to an advertiser-to-business-to-person form of interaction.

FIG. 5 depicts the computer process for handling print requests.

### DETAILED DESCRIPTION OF THE DRAWINGS

The preferred embodiment of this method will be implemented by processes as depicted in the figures described below.

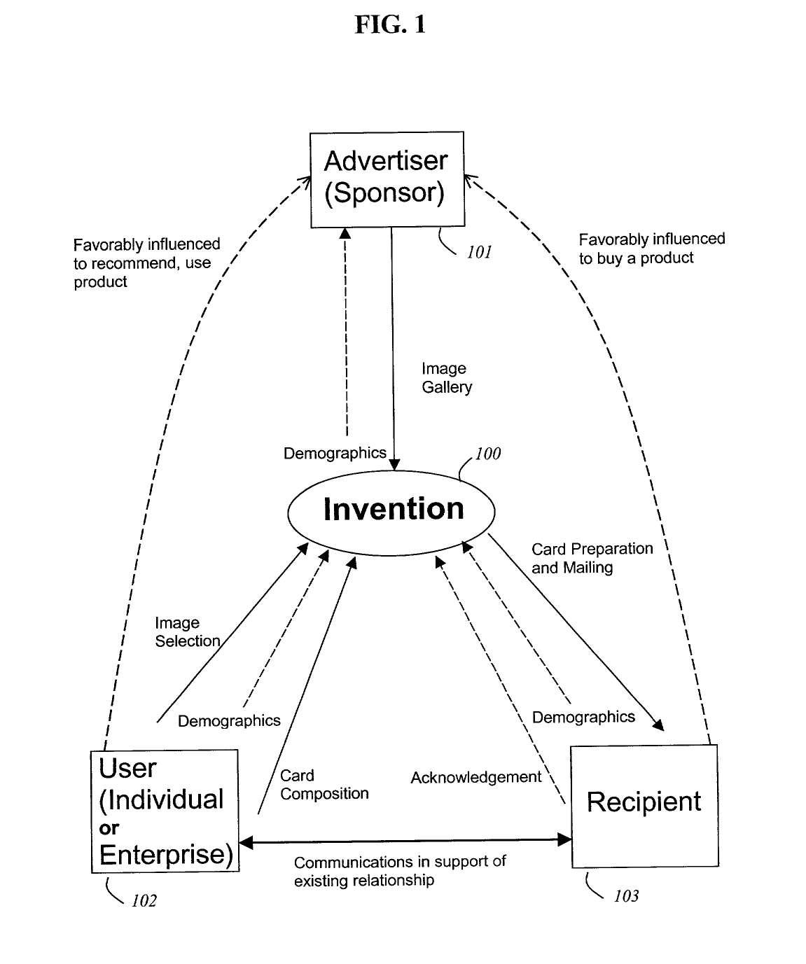

FIG. 1 depicts the overall relationship among three parties, all users of the invention, and the invention. The service provider enterprise 100 applying or operating the invention sits at the center of the relationship, mediating all information flow among the parties. The fact that this invention requires no direct connection among any of the using parties distinguishes this solution from other advertising models.

The advertiser 101 provides funding in part or in whole for the application of the invention. They do this through producing and providing images that will attract users to select these images to carry their messages. And the advertiser images are themselves advertising messages, providing an advertising, marketing, promotional, public relations or public service message. The image information flows from the advertiser 101 to the invention operator 100. In reverse, the invention operator returns to the advertiser accounting and tracking information to show how their images are used. At a most basic level the accounting can show the numbers of cards sent from zip codes and to zip codes. More detailed levels can be made available in accordance with privacy agreements between the users (sender and recipient) and the invention operator.

The user 102 makes use of the image gallery presented by the operator 100 of the invention. The choice of an image will provide a funding source that will cover a portion or the entire cost for preparation and mailing of a product to the recipient. The product could take many forms: a tangible product that is mailed: postcard, flyer, letter; electronic communications: email, facsimile, telephone, wireless. The invention operator may optionally collect from message recipients a response. So, for a dentist sending appointment reminders, for example, the invention operator can provide a means for the recipient to connect to the invention and signal their receipt and agreement with the message. And at a minimal level of reporting the invention will record where and when cards are sent. Thus, if a dentist, for example, maintains an address book and schedule on the invention, the invention can track when cards are automatically prepared and sent. The advertiser receives an advertising effect benefit in two ways from the user finding themselves favorably influenced toward the advertiser and their message. First, they have actively sought out and selected a particular advertiser and their advertising images, because the product appealed to the user, or they expected it to appeal to the recipient, or both. Second, because the user receives a tangible benefit in the form of total or partial support for the cost of the message preparation and delivery, they feel a reciprocal debt to the advertiser.

There exists a return flow of information from the user 102 to the invention operator 100. At the most basic level this will include the identification and minimal demographic information the user must provide to register with the service operating the invention. At another level the advertiser might require or request the completion of a brief demographic survey by the user before they can complete the process of using a selected image. The invention collects this information in a database to report it back to the advertiser.

The recipient 103 receives via the invention operator 100 the prepared message, including both the advertiser 101 message contained in their image, and the message from the user that directed the sending of the image. The recipient will feel favorably disposed to read and even save the message because it will come 102 either as a personal message from a friend or as an important reminder or notice from a trusted professional, such as ones dentist. The recipient will feel favorably disposed toward the advertising message, again because it comes from a source that the recipient trusts, and because the user as sender 102 chose the image with the recipient 103 in mind.

Optionally, the recipient 103 may connect to the invention source to respond to the communication. They may, for example, acknowledge an appointment or reminder message, or perhaps take advantage of a coupon or other offer contained within the sender or advertiser message. The invention collects statistics on these contacts and reports information, consistent with the privacy policy, to the user 102 and advertiser 101.

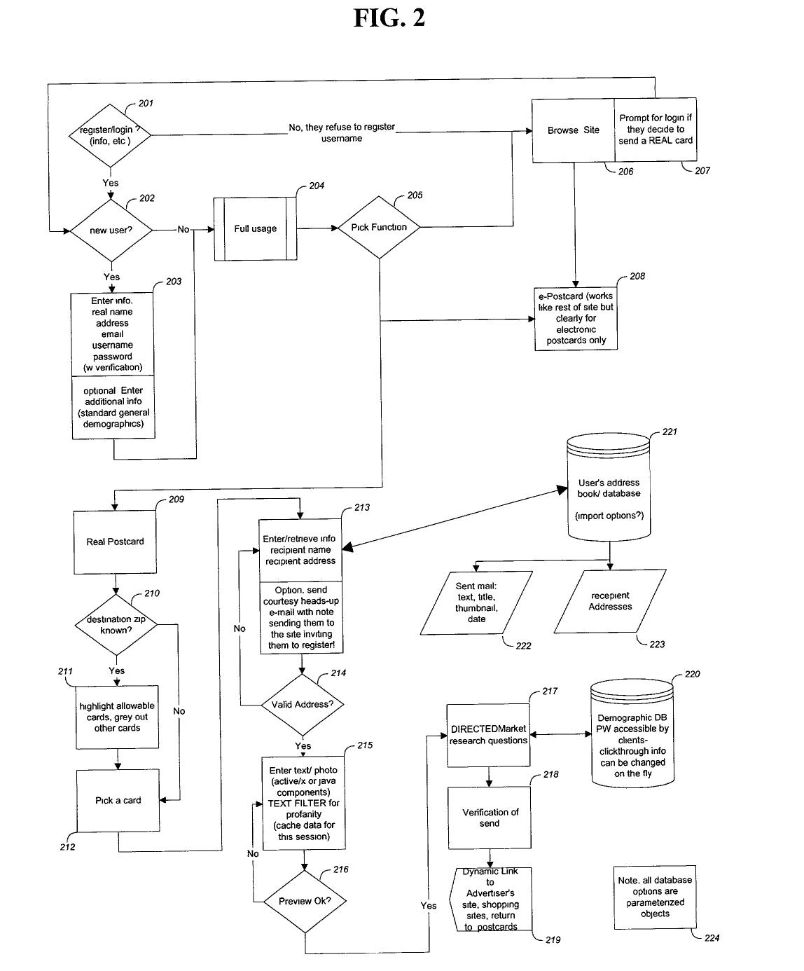

FIG. 2 depicts the computer process for handling the user interaction. It illustrates these aspects of the process:

The user identifies themselves 201 to the invention. They need not log in or register to browse the site 206. However, if they choose to send a message 207, they will be asked for login. When the user logs in 202 they will be asked to register if not found in the database of registered users. At 203 the user will provide basic identifying information and optionally demographic information, consistent with privacy policy and public law. Once they have registered and subsequently logged in, 204 the user has full access to the user functions of the site. At 208 the user can be allowed to send an electronic postcard without logging in.

At the image gallery 209 the invention makes a determination based on zip code of the user 210 (and possibly other factors) to choose which images to present to the user 211. Some advertisers 101 may place restrictions on some or all of the images they provide. For example, an regional advertiser might wish to restrict the usage of their images (and associated sponsorship) to users within their region. The user selects an image 212 to accompany their message and to provide sponsorship for the preparation and delivery of the message.

The user 102 enters addressing information 213 for the message. Optionally the address may come from an address book database 221 that maintains recipient 103 addresses as well as complete records for the messages the user has sent 222.

In an effort to prevent misdirected messages, the invention 100 will apply tests to determine whether the address looks valid, and if not, give the user 102 an opportunity to correct the address 213.

The user 102 has the option to upload or select from the invention 100 presentation a thumbnail image, graphic or picture, a coupon, or other additional textual or visual element 215.

The invention 100 presents the message to the user 102 electronically in a close approximation of the way it will appear to the recipient 103 on receipt. If they user approves of the appearance of the complete product they signal their readiness to have it sent 216.

At this point, after the user 101 has invested energy and thought in selecting an image and preparing a message for sending, they have a commitment to see the process completed. So here the invention 100 asks the user whether they will answer a few brief demographic questions requested by the advertiser 102 supplying the image and sponsorship. Because the user may feel a reciprocal debt to the advertiser for the sponsorship and may feel favorably disposed to the advertiser in any case, they will have a good likelihood of responding to brief, non-invasive questions. Questions are optional, and the user will be permitted to complete the transaction without answering any demographic questions. If they should respond to the questions their answers will be collected 220 for analysis and reporting back to the advertiser.

The invention 100 confirms with the user 102 that their transaction is complete, and at this point 219 it may offer to link the user to the advertiser's web site.

Finally, it is worth noting 224 that all database options, including user interaction test, is maintained in a parameterized database form, such that it may be dynamically adjusted to a particular user. So, for example, the language of the user interaction could be changed from English to the user's native language.

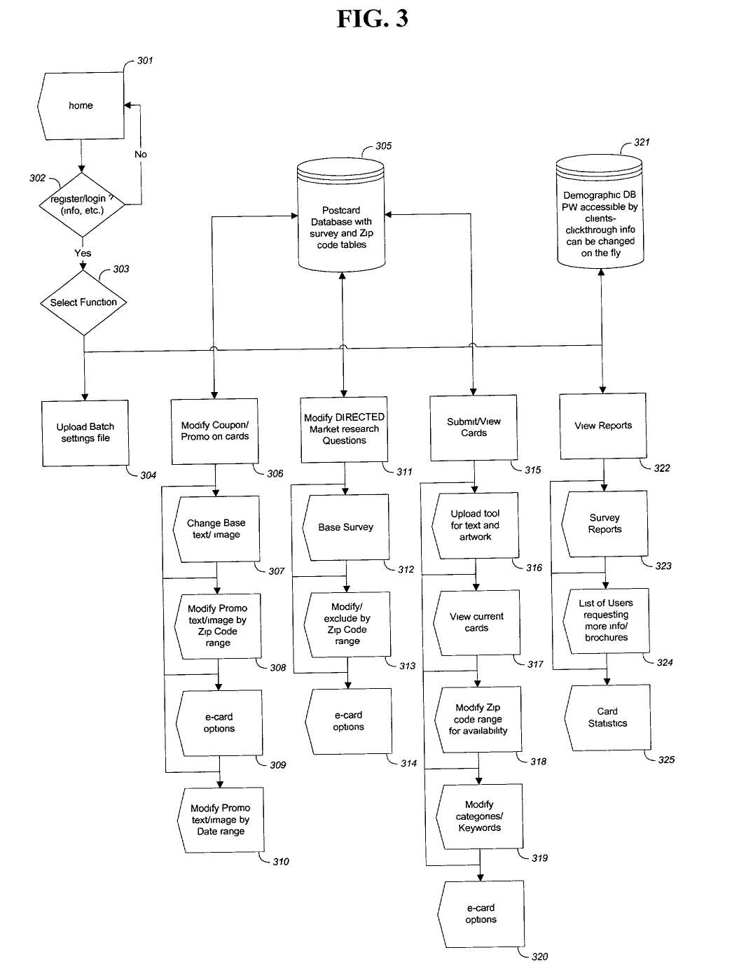

FIG. 3 depicts the processes of the invention 100 for maintaining the image database. It illustrates components of the database directed to the benefit for the advertiser 101, as well as operations on that database.

As a database administrator enters the site 301 they must identify themselves 302 as having the necessary security privileges before they may select 303 a database operation.

The invention permits the use of batch operation 304 as well as interactive operation. Throughout the operation, whether via batch or interactive, the user operates on one or both of two databases: the image (here characterized as “postcard” images) 305 database and the demographics database 306 where the invention records. Demographics related to interactions from users 102 and recipients 103 and the invention 100. An advertiser 102 with appropriate privileges may be given interactive access to the demographics database.

The administrator has the following database operations available to them:

306 Modify the coupon or promotion image or association with advertiser images;

307 Graphically modify the basic image or text of an image;

308 Modify images by zip code range, setting, for example, restrictions on whether certain images are presented to a user 102 based on the zip code of the user;

309 Set whether an image may be used in an electronic card (email-based or web-based) in addition to a print based message;

310 Set for images, coupons and promotions any date restrictions which the advertiser may place; for example, a promotion may expire on a certain date;

311 Set up or modify the demographics questions which an advertiser may associate with the use of an image;

312 Create a base survey for an advertiser for all images;

313 Define zip code restrictions;

314 Set electronic card options based on demographic survey questions;

315 Review and approve the final design of new images;

316 Upload text or artwork for images;

317 View existing cards in the database;

318 Set or change the zip code availability for images;

319 Set or change the categories, keywords and phrases to associate with particular images;

320 Set options on how and which images may be used for electronic cards;

320 View accounting reports;

323 View demographic survey reports;

324 View requests from users 102 or 103 for more information from an advertiser;

325 View statistics on the usage of various images belonging to an advertiser.

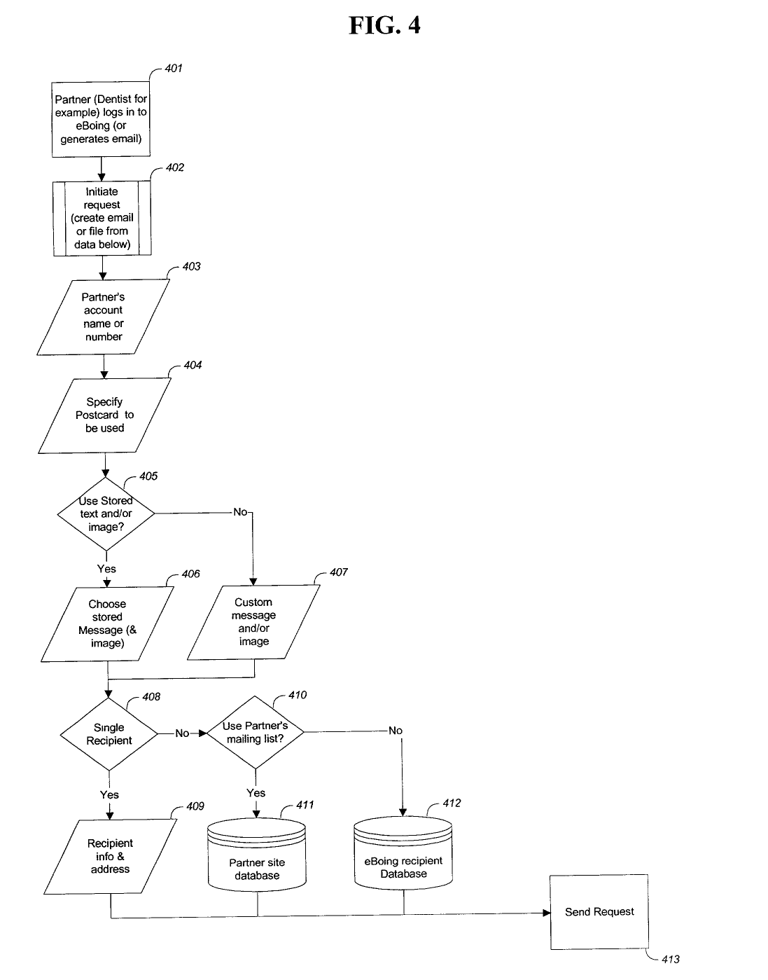

FIG. 4 depicts the application of the invention to a advertiser-to-business-to-person form of interaction. It shows, by way of example, how a service provider, such as a dental practice, might employ the process to send appointment reminders to their patients.

The user 102 connects to the service provider 401 operating the invention 100. Optionally a front-end processor could be provided to allow the user to send an email request to produce a stored transaction. The user initiates the request 402.

To process the request the system demands that the user be identified 202, then the user may specify an image to use 404 for their request.

Because reminder and notice type messages from an enterprise may have a repetitive character, the user may store the text message component 406 for reuse on multiple cards. Otherwise they enter custom text 407 and optionally upload an image for use on a particular card.

If the user indicates the card is for a single recipient 103 the process 408 may proceed immediately to collecting the recipient address for completion of the request. Otherwise, 410 they user may indicate addresses to use from their address book, created or edited earlier or contemporaneously. The information may be uploaded from the user's computer 411. They user may also manually create or edit entries. And the results are store on the database of the service provider 412 operating the invention.

When all components are assembled for a complete message, the user indicates to send the result 413.

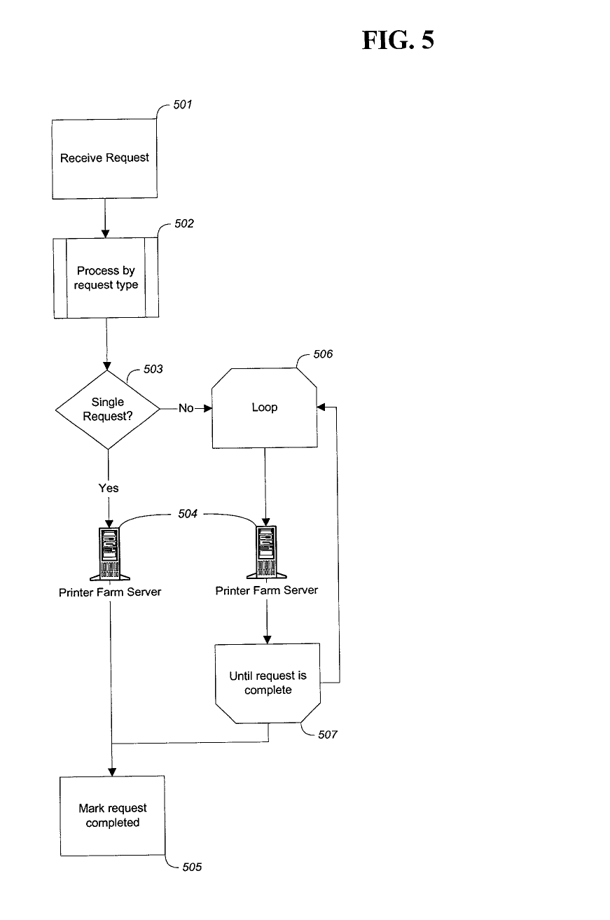

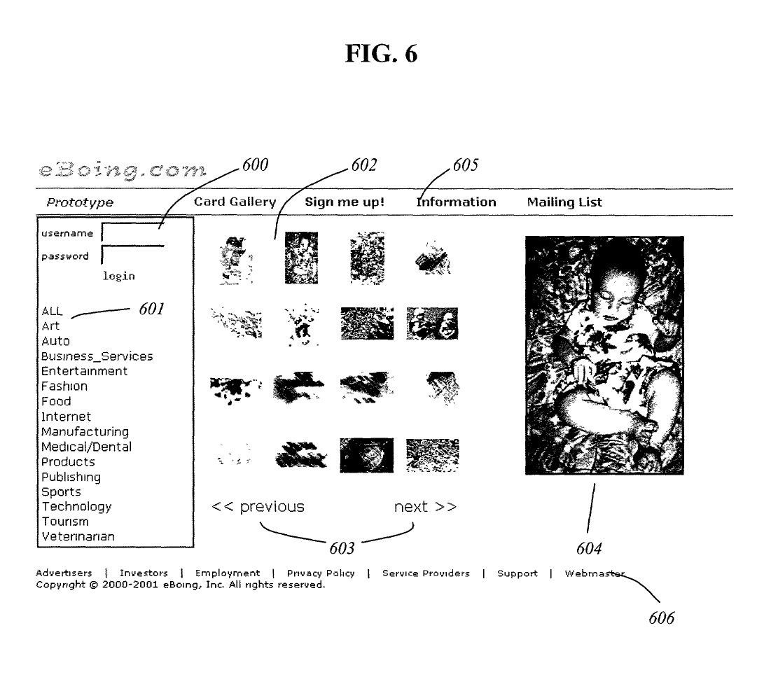

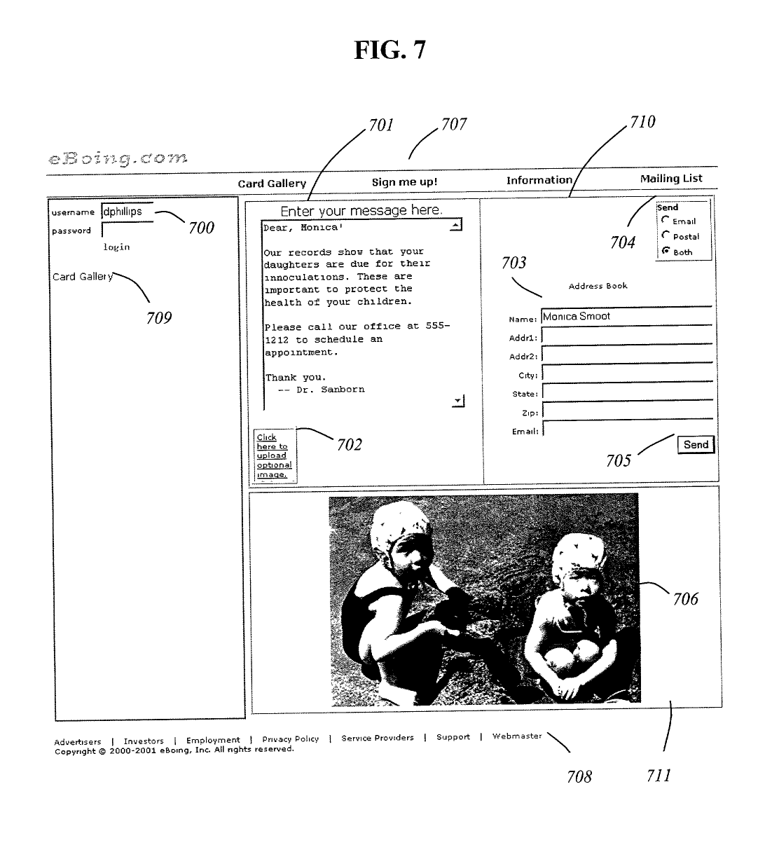

FIG. 5 depicts the computer process for handling print requests, which may include a single request or a repetitive series of requests, as, for example, the case of a dental practice sending a series of reminder messages for a week's worth of appointments.

The system receives a request 501, either on an on-demand, interrupt driven basis, or on the basis of polling a database of such requests. In the case of polling a database the process has the opportunity 202 to group the requests by characteristics. It could, for example, sort the requests to print them in zip code order to facilitate the use of bulk mailing rates. It could group the requests by the type of service demanded. For example, some printers might be set up for and dedicated to the production of postcards, while other printers handled large print pieces. Furthermore, here we depict only printing operations, but the servers could just as well handle message delivery by any of the available electronic options: email, web, facsimile, telephone, wireless.

The requests are actually carried out 504 on one or more servers, here shown as printer farm servers. This signifies that the number of servers dedicated to the operation may be increased or decreased as necessarily to handle the demand under the performance standards of the enterprise operating the invention 100.

Simple requests will flow straight through a printer to an acknowledgement process 505 where the invention 100 records that a particular request has been satisfied, and records statistical and demographic information for that request in the database 321.

Where requests can be set up as a repeating process they are handled in a loop 506 fashion until all the related requests are complete 207. For example, a dental office reminder card may all carry the same image on one side of the card and message on the other side, with only the address changing between cards. For efficiency a printer 504 with a storage capability can be directed 502 to handle such requests, producing greater efficiency because the printer can repeatedly produce the same image without it having to be reloaded each time.

FIG. 6 gives an example for application of the invention, showing a main navigation page presented when the user connects to a site serving up the invention. The user 102 may log in 600 at this point in their interaction, or defer that action until later.

The side navigation panel 601 lists categories for display different groupings of images. In other embodiments the user may also have a search bar where they can enter specific key words or phrases or advertiser name.

When the user 102 first enters the display page they will be shown all images that are available to them under any criteria FIG. 3 that advertisers 101 may apply to the use of their images. The images are shown in a gallery 602 presentation of thumbnail images. When the number of images exceed the spaces available in the gallery, the screen will display previous and next navigators 603 so the user can move to other galleries full of images.

When the user hovers or passes their mouse or other navigation device over a thumbnail image a large size image appears in a separate display space 604 to give the user a better view of the contents of the image.

Internet web standard top 605 and bottom 606 navigation bars provide the user an easy means to move to other sections of the site providing service for the invention method.

FIG. 7 As with the main navigation page FIG. 6 the user 102 has the opportunity to log in here 700, or they may defer logging in, up until the point that they actually request the sending of a card.

The screen work areas for the user 710 and 711 are drawn in such a way to depict the physical analogue of the product they are creating, in this case a postcard. 710 appears as the back or message side of a card, while 711 appears as the front or picture side.

The user enters their message in text area 701, and optionally they may upload a thumbnail image to be included with their message by using the upload control 702.

After entering the recipient 104 address 703 the user indicates the desired method of delivery for the card 704, here showing choices of email or postal or both. On reviewing the card contents, both the elements the user has entered 701, 702, 703 and the image they have chosen 706, the user indicates their readiness to have the card sent by signaling with an indicator 705.

Internet web standard top 707 and bottom 708 navigation bars provide the user an easy means to move to other sections of the site providing service for the invention method. Additionally, a side navigator 709 can show links that are applicable to the current context of the user interaction.

Conclusion

We have described here an invention that provides a method for self-selecting advertising information and automatically obtaining the benefit of subsidized mailing and printing costs. However, we do not intend the above description to limit the scope of the invention. The claims section defines the scope of the invention.

We claim:

1. A method for advertising, composed of these steps:
the service provider employing this method presents an image gallery that displays a variety of advertising images sized to fit, when printed, on one side of a product;
the user may browse and search through the gallery;
the user indicates an image selection;
the user fills in a form to produce a personal message and a mailing address;
the user may upload an image for inclusion with their message;
the user may indicate a coupon to include with their message;
the user identifies themselves to the system implementing the process;
the user signals completion of the card and requests to send it;
the service provider makes a complete product by printing the advertising image on one side of the product, and printing the user's personal message, optional image, and address on the other side of the product;
the service provider adds sufficient postage to the product and deposits it with the postal service for mailing.

2. The method of claim 1 where the device for presenting the image gallery is a computer connected to an address on a public network.

3. The method of claim 1 where the device for presenting the image gallery is a computer connected to a private network.

4. The method of claim 1 where the mechanism for implementing this invention is provided by a standalone system, such as a kiosk.

5. The method of claim 1 where the product is a printable, mailable item such as a postcard, flyer or letter.

6. The method of claim 1 where the user may identify themselves at any point in the process prior to completing the transaction of specifying and requesting production of the product.

7. The method of claim 1 where the user must identify themselves prior to completing a transaction, with at least their name and mailing address, and may optionally include an email address, telephone number, and credit or debit card information.

8. The method of claim 1 where the user may be an individual person or an enterprise such as a sole practitioner, a professional practice, a small business, a governmental agency, or a non-profit group.

9. The method of claim 1 where the message takes the form of a personal communication between individuals.

10. The method of claim 1 where the message takes the form of notification information from an enterprise, such as a reminder of an appointment, notice of scheduled services due, notice of changes in products or services, notice of available services and products.

11. The method of claim 1 where the advertisement applies to a created or manufactured object or goods, or a service.

12. The method of claim 1 where the advertising image may consist of a coupon or promotional code.

13. The method of claim 1 where the user may combine advertising images or coupons or promotional codes on the front or back of the printed product.

14. A computer program product composed of program code to:
select and display images;
permit the user to specify subsets of images to display or to search for specific images or categories of images;
display an electronic analogue of a printable medium, such as a postcard, to give the user the experience of filling out a postcard;
combine selected images, whether composed of material stored and presented by the producer system, or uploaded or otherwise created by the user;
track transaction requests, recording the sender and their identification, the recipient and their address, and the unique components of the composition to be printed;
track production results and notify users of the results for their transactions;
track for advertisers the usage associated with their images;
track and allocate production and mailing expenses among advertisers and users;
prepare for delivery the advertising and user messages in printed form;
prepare and deliver the advertising and user messages in electronic form.

15. A method that permits delivery of the advertising and the user's message created as described in claim 1, in electronic form as well as in printed form.

16. The method of claim 15 where the process may deliver the advertising and the user's message by means of one or more of the following or similar forms: web-based electronic card pick up, email based electronic card, wireless communication, facsimile, and telephone message.
